(19) United States
(12) Patent Application Publication
(10) Pub. No.: US 2016/0085396 A1
(43) Pub. Date: Mar. 24, 2016

(54) INTERACTIVE TEXT PREVIEW

(71) Applicant: Microsoft Corporation, Redmond, WA (US)

(72) Inventors: Ryan Chandler Pendlay, Bellevue, WA (US); Nathan Radebaugh, Seattle, WA (US); Mohammed Kaleemur Rahman, Seattle, WA (US); Keri Kruse Moran, Bellevue, WA (US); Ramrajprabu Balasubramanian, Renton, WA (US); Tim Kannapel, Redmond, WA (US); Kenton Allen Shipley, Woodinville, WA (US); Brian David Cross, Seattle, WA (US)

(21) Appl. No.: 14/495,299

(22) Filed: Sep. 24, 2014

(51) Int. Cl. G06F 3/0484; G06F 3/14; G06F 17/24

(52) U.S. Cl. CPC G06F 3/0484; G06F 17/24; G06F 3/1423; G06F 3/1415

(57) ABSTRACT

One or more techniques and/or systems are provided for providing interactive text preview. For example, a primary device (e.g., a smart phone) establishes a communication channel with a secondary device (e.g., a television). The primary device projects an application interface, of an application hosted on the primary device, to a secondary display of the secondary device. An interrogation connection is established with a text entry canvas of the application interface. The primary device listens through the interrogation connection to identify text input data directed towards the text entry canvas. An interactive text preview interface, populated with textual information derived from the text input data, is displayed on a primary display of the primary device. In this way, the user may naturally preview text entry through the primary device (e.g., and does not have to look up to the television to see what is being typed).

### BACKGROUND

Many users may interact with various types of computing devices, such as laptops, tablets, personal computers, mobile phones, kiosks, videogame systems, etc. In an example, a user may utilize a mobile phone to obtain driving directions, through a map interface, to a destination. In another example, a user may utilize a store kiosk to print coupons and lookup inventory through a store user interface.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for providing interactive text preview are provided herein. In an example of providing interactive text preview, a primary device establishes a communication channel with a secondary device. The primary device projects an application interface, of an application hosted on the primary device, to a secondary display of the secondary device. The primary device establishes an interrogation connection with a text entry canvas of the application interface. The text entry canvas is displayed on the secondary display. The primary device listens through the interrogation connection to identify text input data directed towards the text entry canvas. The primary device displays an interactive text preview interface, populated with textual information derived from the text input data, on a primary display of the primary device.

In an example of providing interactive text preview, a primary device establishes a communication channel with a secondary device. The primary device maintains a primary visual tree for a primary display of the primary device. The primary device maintains a secondary visual tree for a secondary display of the secondary device. The primary device projects an application interface, of an application hosted on the primary device, to the secondary display of the secondary device based upon the secondary visual tree. The primary device establishes an interrogation connection with a text entry canvas of the application interface. The text entry canvas is displayed on the secondary display. The primary device listens through the interrogation connection to identify text input data directed towards the text entry canvas. The primary device displays an interactive text preview interface, populated with textual information derived from the text input data, on the primary display of the primary device based upon the primary visual tree.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of providing interactive text preview.

FIG. 2A is a component block diagram illustrating an exemplary system for providing interactive text preview.

FIG. 2B is a component block diagram illustrating an exemplary system for providing interactive text preview, where a text selection operation is facilitated.

FIG. 3A is a component block diagram illustrating an exemplary system for providing interactive text preview, where a primary display characteristic is applied to textual information.

FIG. 3B is a component block diagram illustrating an exemplary system for providing interactive text preview, where a primary display characteristic is applied to textual information.

FIG. 3C is a component block diagram illustrating an exemplary system for providing interactive text preview, where textual information is updated based upon text entry canvas modification.

FIG. 4A is a component block diagram illustrating an exemplary system for providing interactive text preview.

FIG. 4B is a component block diagram illustrating an exemplary system for providing interactive text preview, where modified text input data is projected to a text entry canvas.

FIG. 5 is an illustration of an exemplary computer readable medium wherein processor-executable instructions configured to embody one or more of the provisions set forth herein may be comprised.

FIG. 6 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more techniques and/or systems for providing interactive text preview are provided herein. A user may desire to project an application from a primary device (e.g., a smart phone) to a secondary device (e.g., a television), such that an application interface, of the application, is projected to the secondary device according to device characteristics of the secondary device (e.g., matching an aspect ratio of the secondary device). Because the application is executing on the primary device but is displayed on a secondary screen of the secondary device, the user may interact with the primary device to input text into text entry canvases, such as a text entry field (e.g., text input boxes), of the application interface. However, the user may naturally want to look at the primary device while inputting text into the primary device, but the application interface may be merely displayed on the secondary display (e.g., requiring the user to frequently look up and down from the primary device to the secondary device and back again). Accordingly, as provided herein, a text entry canvas may be interrogated to identify text input data being inputted into the text entry canvas, and an interactive text preview interface, populated with textual information derived from the text input data, may be displayed on a primary display of the primary device. In this way, the user may naturally look at the interactive text preview interface on the primary display while inputting text through the primary device, which may improve the user's experience because the user receives tactile feedback from the primary device (e.g., improving text input accuracy). Because the interactive text preview interface is displayed on the primary display and the application interface is displayed on the secondary display, more screen real estate is freed up on the primary display and/or the secondary display than if the interactive text preview interface and the application interface were displayed on the same display (e.g., more screen space of the secondary display may be devoted to the application interface and/or other interfaces than if the interactive text preview interface was displayed on the secondary display).

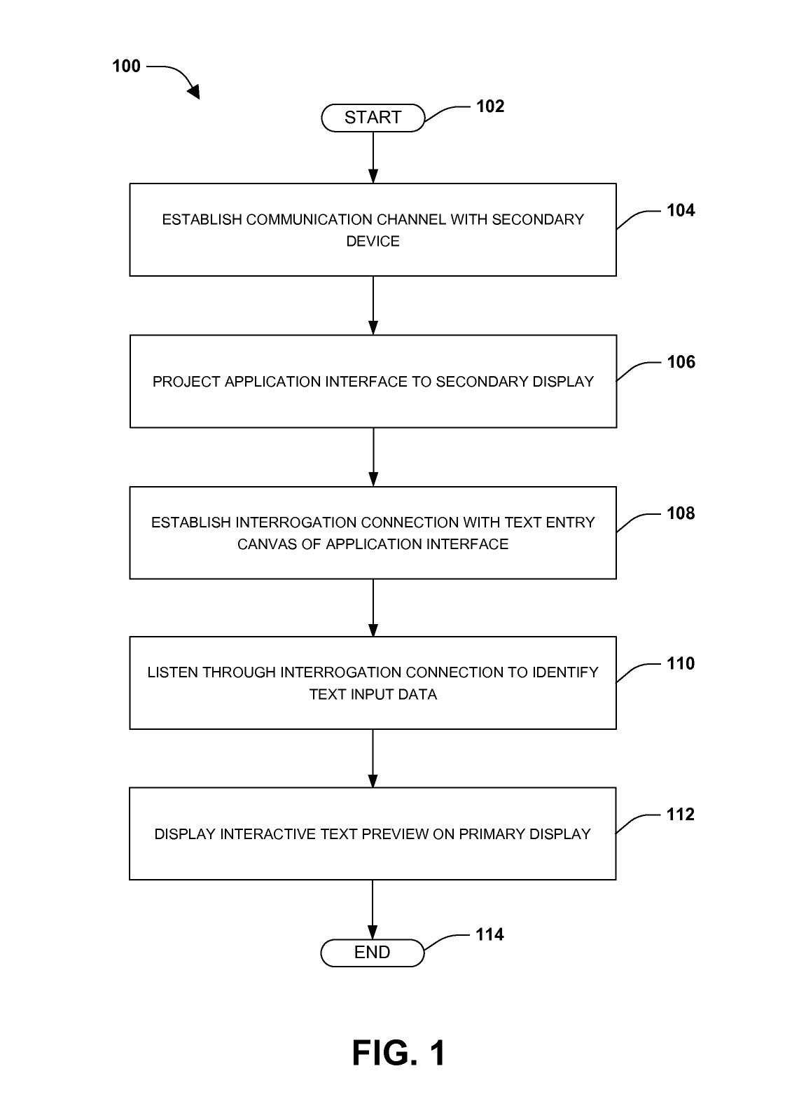

An embodiment of providing interactive text preview is illustrated by an exemplary method 100 of FIG. 1. At 102, the method starts. At 104, a primary device, such as a smart phone primary device or any other computing device, may host an application, such as a social network application. The social network application may execute on a processor of the smart phone primary device, and may utilize memory and/or other resources of the smart phone primary device for execution. The primary device may establish a communication channel with a secondary device (e.g., a television, an interactive touch display, a laptop, a personal computer, a tablet, an appliance such as a refrigerator, a car navigation system, etc.). For example, the smart phone primary device may establish the communication channel (e.g., a Bluetooth communication channel) with a television secondary device.

At 106, the primary device may project an application interface, of the application hosted on the primary device, to a secondary display of the secondary device. For example, the smart phone primary device may project a social network application interface (e.g., populated with a social network profile of a user of the smart phone primary device) to a television secondary display of the television secondary device. In an example, the social network application is executing on the smart phone primary device and is not executing on the television secondary device, and thus the smart phone primary device is driving the television secondary display based upon the execution of the social network application on the smart phone primary device. In an example, the social network application interface is not displayed on a smart phone primary display of the smart phone primary device, and thus the television secondary display and the smart phone primary display are not mirrors of one another (e.g., the social network application interface may be visually formatted, such as having an aspect ratio, for the television secondary display as opposed to the smart phone primary display). In an example, the smart phone primary device may maintain a secondary visual tree for the television secondary display (e.g., user interface elements of the social network application interface and/or display information of the television secondary display may be stored as nodes within the secondary visual tree). The social network application interface may be projected to the television secondary display based upon the secondary visual tree (e.g., display information about the television secondary display may be used to render the user interface elements of the social network application interface on the television secondary display).

At 108, the primary device may establish an interrogation connection with a text entry canvas (e.g., a text box user interface element) of the application interface. The text entry canvas may be displayed on the secondary display (e.g., but not on a primary display of the primary device). For example, the social network application interface may display the social network profile of the user and a send message text entry canvas through which the user may compose a social network message. At 110, the primary device may listen through the interrogation connection to identify text input data directed towards the text entry canvas. The text input data may be input into the primary device and may be targeted to the secondary device. In an example, the smart phone primary device may interrogate the send message text entry canvas to determine whether text has been input into the send message text entry canvas. For example, responsive to the user selecting the send message text entry canvas using input on the smart phone primary device, a virtual keyboard may be displayed for the user (e.g., on the smart phone primary display). Input through the virtual keyboard that is directed towards the send message text entry canvas may be detected as the text input data (e.g., which may be identified by interrogating the send message text entry canvas to detect text being input to and displayed through the send message text entry canvas on the secondary device).

At 112, an interactive text preview interface, populated with textual information derived from the text input data, may be displayed on the primary display of the primary device. For example, the user may start to input (e.g., through the virtual keyboard) a text string “Hey Joe, do you” as input to the send message text entry canvas. Because the text string “Hey Joe, do you” is being displayed on the television secondary display, but the user is providing the input through the smart phone primary device, the interactive text preview interface may allow the user to visualize the text string “Hey Joe, do you” on the smart phone primary display. Thus, the user may input text on the smart phone primary display and visualize such input text through the interactive text preview interface. In an example, the user may cut or copy text or any other data (e.g., from an email, from a document, from a website, etc.) on the primary device and paste the text into the interactive text preview interface on the primary device. In this way, the user may naturally look at the smart phone primary display while inputting text on the smart phone primary device, which is provided as input to the social network application for the send message text entry canvas of the social network application interface displayed on the television secondary display. The smart phone primary device may provide tactile feedback, for the social network application interface displayed on the television secondary display, to the user through the interactive text preview interface displayed on the smart phone primary display. In an example, the interactive text preview interface is not displayed on the secondary display, which may free up screen real estate of the television secondary display for other information (e.g., the social network application interface may utilize more screen space of the television secondary display than if the interactive text preview interface was displayed on the television secondary display).

In an example, the smart phone primary device may maintain a primary visual tree for the smart phone primary display. The primary visual tree may indicate that the smart phone primary device has different display capabilities than the television secondary display (e.g., the primary visual tree may comprise nodes populated with display information, such as an aspect ratio, a resolution, color capabilities, etc., of the smart phone primary display, which may be different than display information, of the television secondary display, stored within the secondary visual tree). The interactive text preview interface may be displayed on the smart phone primary display based upon the primary visual tree (e.g., display information about the smart phone primary display may be used to render the user interface elements of the interactive text preview interface on the smart phone primary display).

In an example, a primary display characteristic may be applied to the textual information populated within the interactive text preview interface. The primary display characteristic may be different than a secondary display characteristic of the text entry canvas. For example, the text string “Hey Joe, do you”, displayed as the textual information populated within the interactive text preview interface displayed on the smart phone primary display, may have a different font, aspect ratio, color, language, and/or other property than the text string “Hey Joe, do you” displayed through the send message text entry canvas of the social network application interface displayed on the television secondary display. In an example, the user may select at least some of the textual information populated within the interactive text preview interface. For example, responsive to the user selecting “Hey Joe”, at least one of a text copy operation, a text cut operation, or a subsequent text paste operation may be facilitated.

In an example, the primary device may be configured to listen through the interrogation connection to identify a text entry canvas modification by the application to the text entry canvas. For example, the user may continue to input “Hey Joe, do you wnat to go out!” as input to the send message text entry canvas, which may be automatically spellcheck corrected by the social network application to “Hey Joe, do you want to go out!”. The smart phone primary device may update the textual information of the interactive text preview interface based upon the text entry canvas modification.

In an example, the primary device may be configured to modify the text input data to create modified text input data. The modified text input data may be projected to the text entry canvas for display through the application interface on the secondary display. For example, the user may submit a request for the smart phone primary device to translate the text string “Hey Joe, do you” into German to create a German text string. The smart phone primary device may project the German text string to the social network application interface (e.g., populate the text entry canvas with the German text string). At 114, the method ends.

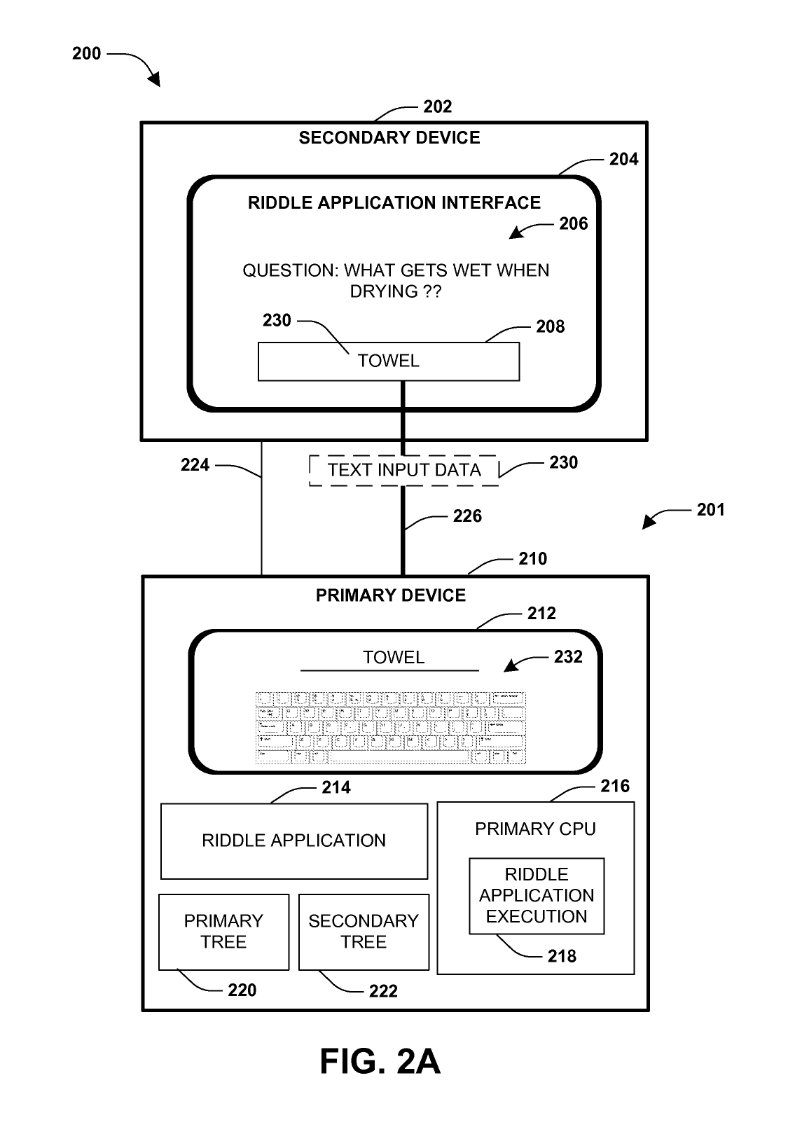

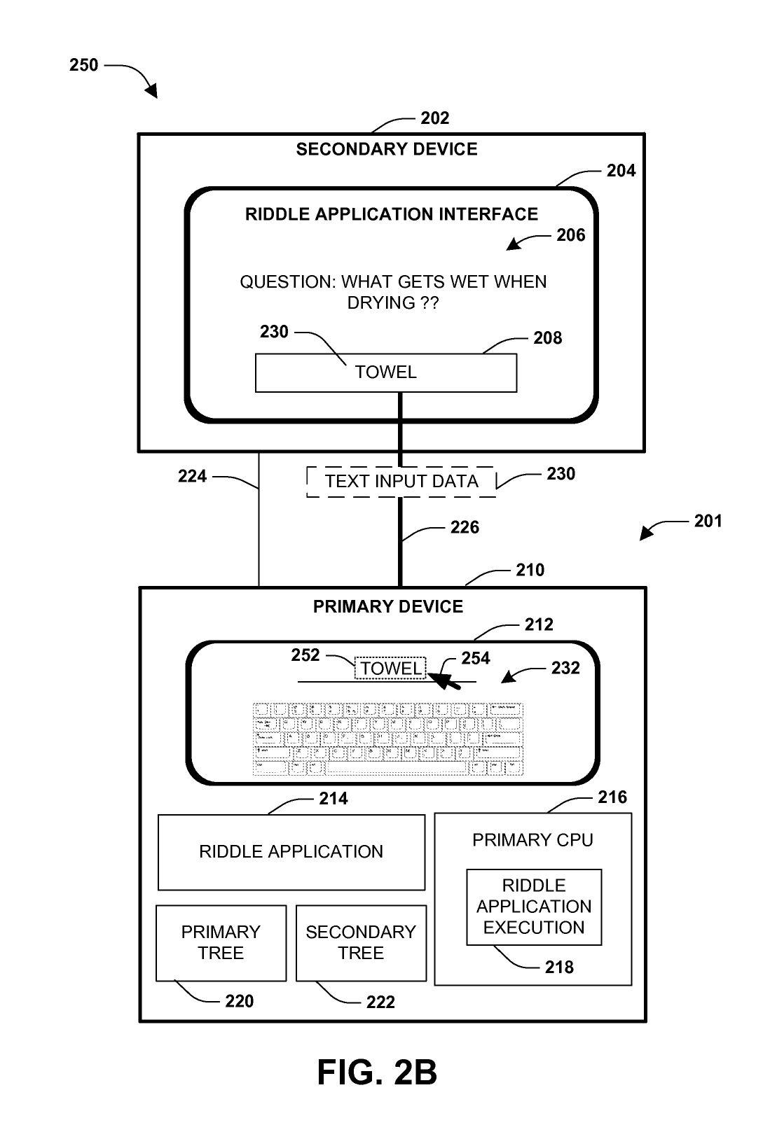

FIGS. 2A and 2B illustrate examples of a system 201, comprising a primary device 210, for providing an interactive text preview. FIG. 2A illustrates an example 200 of the primary device 210 (e.g., a personal computer, a laptop, a tablet, a smart phone, etc.) establishing a communication channel 224 (e.g., a Bluetooth connection) with a secondary device 202 (e.g., a personal computer, a laptop, a tablet, a smart phone, a television, a touch enabled display, an appliance, a car navigation system, etc.). The primary device 210 may host a riddle application 214 that may execute 218 on a primary CPU 216 of the primary device 210. The primary device 210 may project a riddle application interface 206, of the riddle application 214, to a secondary display 204 of the secondary device 202. For example, the primary device 210 may maintain a secondary visual tree 222 comprising nodes within which user interface elements and/or display information of the riddle application interface 206 and/or the secondary display 204 are stored. The primary device 210 may project the riddle application interface 206 based upon the secondary visual tree 222.

The riddle application interface 206 may comprise various user interface elements, such as a text string “Question: what gets wet when drying ??”, a text entry canvas 208 (e.g., a text input box), etc. In an example, the user may provide input through the primary device 210 to control the riddle application interface 206. For example, although the riddle application interface 206 and thus the text entry canvas 208 are not displayed on a primary display 212 of the primary device 210, a touch sensitive surface of the primary device 210 may be used as a touchpad for the secondary device 202. A swipe, tap and/or other gesture on the touch sensitive surface of the primary device 202 may therefore control movement, activity, etc. of a cursor, for example, displayed within the secondary display 204 (e.g., thus allowing the user to use the primary device 210 to place the cursor within and thus select the text entry canvas 208). A keyboard interface may be displayed on the primary display 212 of the primary device 210 (e.g., responsive to selection of the text entry canvas). The user may being to type the word “towel” through the keyboard interface as input into the text entry canvas 208. As provided herein, the primary device 210 may establish an interrogation connection 226 with the text entry canvas 208. It may be appreciated that the interrogation connection 226 may allow text input data 230 to be obtained from the execution 218 of the riddle application 214 on the primary CPU 216 and/or from the secondary tree 222, and that the interrogation connection 226 is illustrated as connected to the text entry canvas 208 merely for illustrative purposes. The primary device 210 may listen through the interrogation connection 226 to identify the text input data 230 that is directed towards the text entry canvas 208 (e.g., the text string “towel”). The primary device 210 may display an interactive text preview interface 232, populated with textual information (e.g., the text string “towel”) derived from the text input data 230, on the primary display 212 of the primary device 210. In an example, the primary device 210 may maintain a primary visual tree 220 comprising nodes within which user interface elements and/or display information of the interactive text preview interface 232 and/or the primary display 212 are stored. The primary device 210 may utilize the primary visual tree 220 to display the interactive text preview interface 232.

In an example, the riddle application interface 206 is projected and displayed (e.g., rendered by the primary device 210 based upon the execution 218 of the riddle application 214 by the primary CPU 216) on the secondary display 204 and not the primary display 212. In an example, the interactive text preview interface 232 is displayed on the primary display 212 (e.g., concurrent with the display of the riddle application interface 206 on the secondary display 204) and not the secondary display 204. In this way, additional display real estate is available because the riddle application interface 206 and the interactive text preview interface 232 are not displayed on the same display. The user may naturally look at the interactive text preview interface 232 for tactile feedback while typing (e.g., through the keyboard interface) on the primary device 210 as input to the riddle application interface 206 displayed on the secondary display 204.

FIG. 2B illustrates an example 250 of the primary device 210 receiving a user selection 252 of the textual information, such as the text string “towel”, populated within the interactive text preview interface 232 (e.g., utilizing a cursor 254). The primary device 210 may facilitate a text copy operation, a text cut operation, a text paste operation, and/or any other operation for the selected textual information. For example, the user may cut the text string “towel” from the interactive text preview interface 232, and paste the text string “towel” into another application hosted by the primary device 210. In an example, the text string “towel” may be removed from the text entry canvas 208 based upon the text cut operation. In another example, the text string “towel” remains within the text entry canvas 208 notwithstanding the text cut operation.

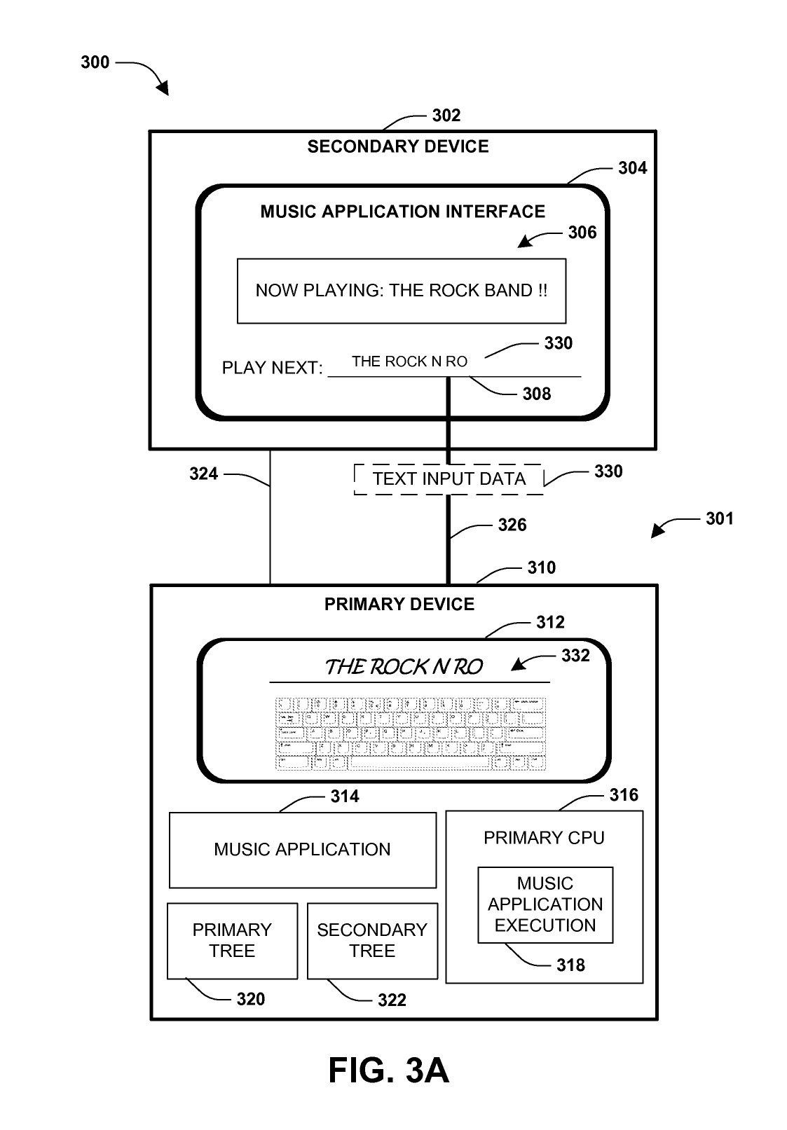

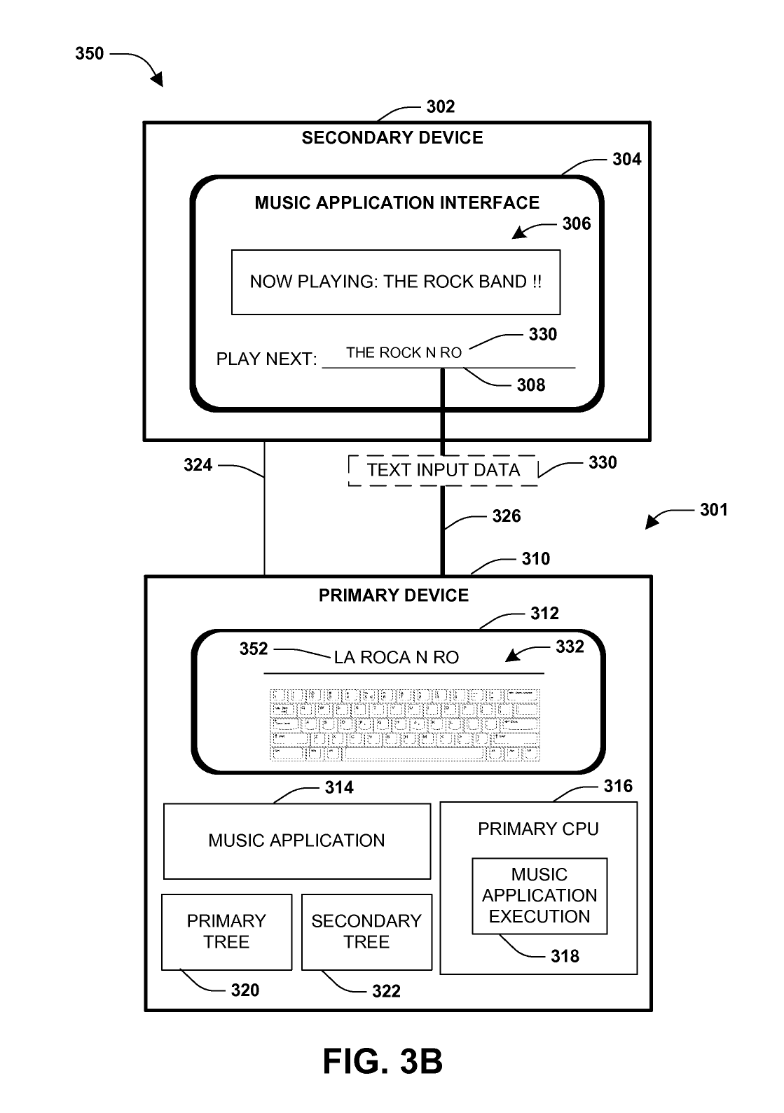

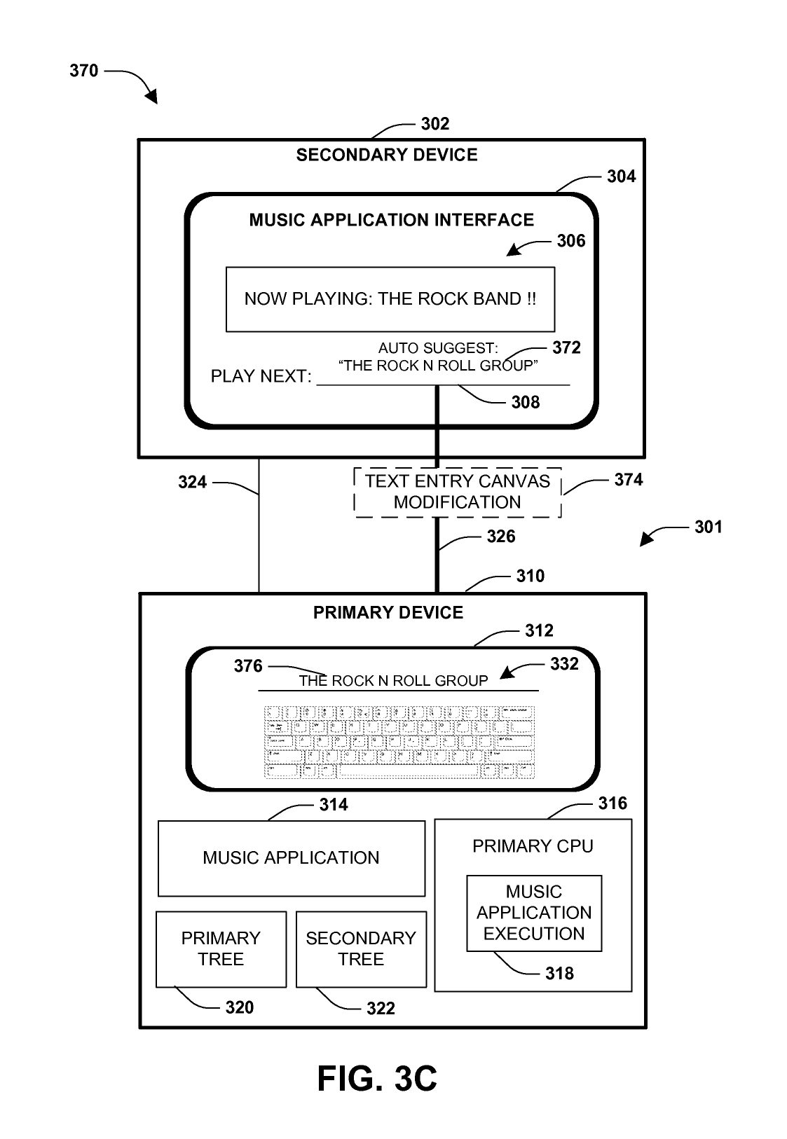

FIGS. 3A-3C illustrate examples of a system 301, comprising a primary device 310, for providing an interactive text preview. FIG. 3A illustrates an example 300 of the primary device 310 establishing a communication channel 324 with a secondary device 302. The primary device 310 may host a music application 314 that may execute 318 on a primary CPU 316 of the primary device 310. The primary device 310 may project a music application interface 306, of the music application 314, to a secondary display 304 of the secondary device 302. For example, the primary device 310 may maintain a secondary visual tree 322 comprising nodes within which user interface elements and/or display information of the music application interface 306 and/or the secondary display 304 are stored. The primary device 310 may project the music application interface 306 based upon the secondary visual tree 322.

The music application interface 306 may comprise various user interface elements, such as a now playing display element, a text entry canvas 308 (e.g., a text input box) associated with a play next interface element, etc. In an example, the user may provide input through the primary device 310 to control the music application interface 306. For example, although the music application interface 306 and thus the text entry canvas 308 are not displayed on a primary display 312 of the primary device 310, a touch sensitive surface of the primary device 310 may be used as a touchpad for the secondary device 302. A swipe, tap and/or other gesture on the touch sensitive surface of the primary device 302 may therefore control movement, activity, etc. of a cursor, for example, displayed within the secondary display 304 (e.g., thus allowing the user to use the primary device 310 to place the cursor within and thus select the text entry canvas 308). A keyboard interface may be displayed on the primary display 312 of the primary device 310 (e.g., responsive to selection of the text entry canvas). The user may being to type the phrase “The Rock N Ro” through the keyboard interface as input into the text entry canvas 308. As provided herein, the primary device 308 may establish an interrogation connection 326 with the text entry canvas 308. It may be appreciated that the interrogation connection 326 may allow text input data 330 to be obtained from the execution 318 of the music application 314 on the primary CPU 316 and/or from the secondary tree 322, and that the interrogation connection 326 is illustrated as connected to the text entry canvas 308 merely for illustrative purposes. The primary device 310 may listen through the interrogation connection 326 to identify text input data 330 directed towards the text entry canvas 308 (e.g., the text string “The Rock N Ro”). The primary device 310 may display an interactive text preview interface 332, populated with textual information (e.g., the text string “The Rock N Ro”) derived from the text input data 330, on the primary display 312 of the primary device 310. In an example, the primary device 310 may maintain a primary visual tree 320 comprising nodes within which user interface elements and/or display information of the interactive text preview interface 332 and/or the primary display 312 are stored. The primary device 310 may utilize the primary visual tree 320 to display the interactive text preview interface 332. In an example, a primary display characteristic (e.g., a 12 pt, bold, and italic Kristen ITC font) may be applied to the textual information, such as the text string “The Rock N Ro”, which may be different than a secondary display characteristic of the text entry canvas 308 (e.g., a 10 pt, non-bold, and non-italic Arial font).

In an example, the music application interface 306 is projected and displayed (e.g., rendered by the primary device 310 based upon the execution 318 of the music application 314 by the primary CPU 316) on the secondary display 304 and not the primary display 312. In an example, the interactive text preview interface 332 is displayed on the primary display 312 (e.g., concurrent with the display of the music application interface 306 on the secondary display 304) and not the secondary display 304. In this way, additional display real estate is available because the music application interface 306 and the interactive text preview interface 332 are not displayed on the same display. The user may naturally look at the interactive text preview interface 332 for tactile feedback while typing (e.g., through the keyboard interface) on the primary device 310 as input to the music application interface 306 displayed on the secondary display 304.

FIG. 3B illustrates an example 350 of the primary device 310 applying a language primary display characteristic to the textual information, such as the text string “The Rock N Ro”, resulting in a Spanish translation “LA ROCA N RO” 352 of the text string “The Rock N Ro”. The Spanish translation “LA ROCA N RO” 352 may be displayed through the interactive text preview interface 332, such as concurrently with the display of the text string “The Rock N Ro” in English through the text entry canvas 308 displayed on the secondary display 304.

FIG. 3C illustrates an example 370 of the primary device 310 updating the textual information displayed through the interactive text preview interface 332. For example, the primary device 320 may listen through the interrogation connection 326 to identify a text entry canvas modification 374 by the music application 314 to the text entry canvas 308. The text entry canvas modification 374 may correspond to an auto completion suggestion by the music application 314 of a suggestion phrase “The Rock N Roll Group” 372 to autocomplete the text string “The Rock N Ro”. The primary device 310 may update the textual information of the text entry canvas 332 to comprise updated textual information “The Rock N Roll Group” 376 based upon the text entry canvas modification 374.

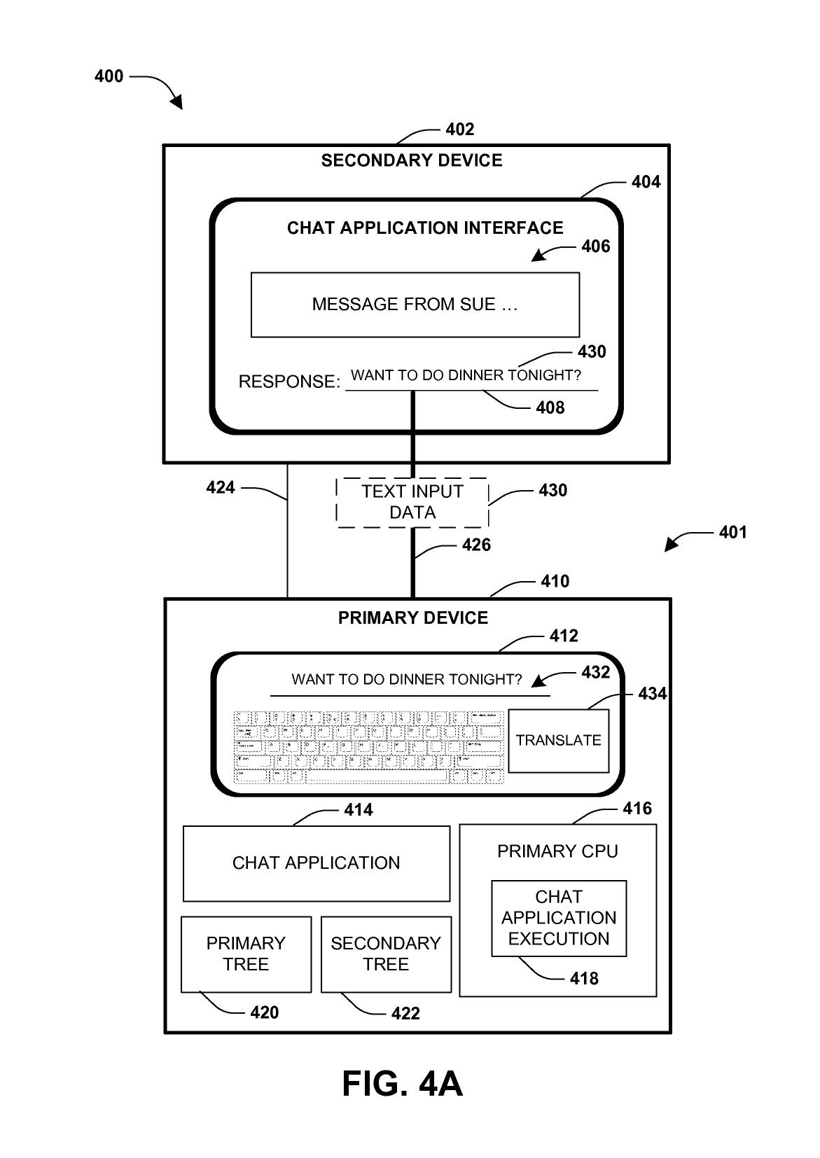

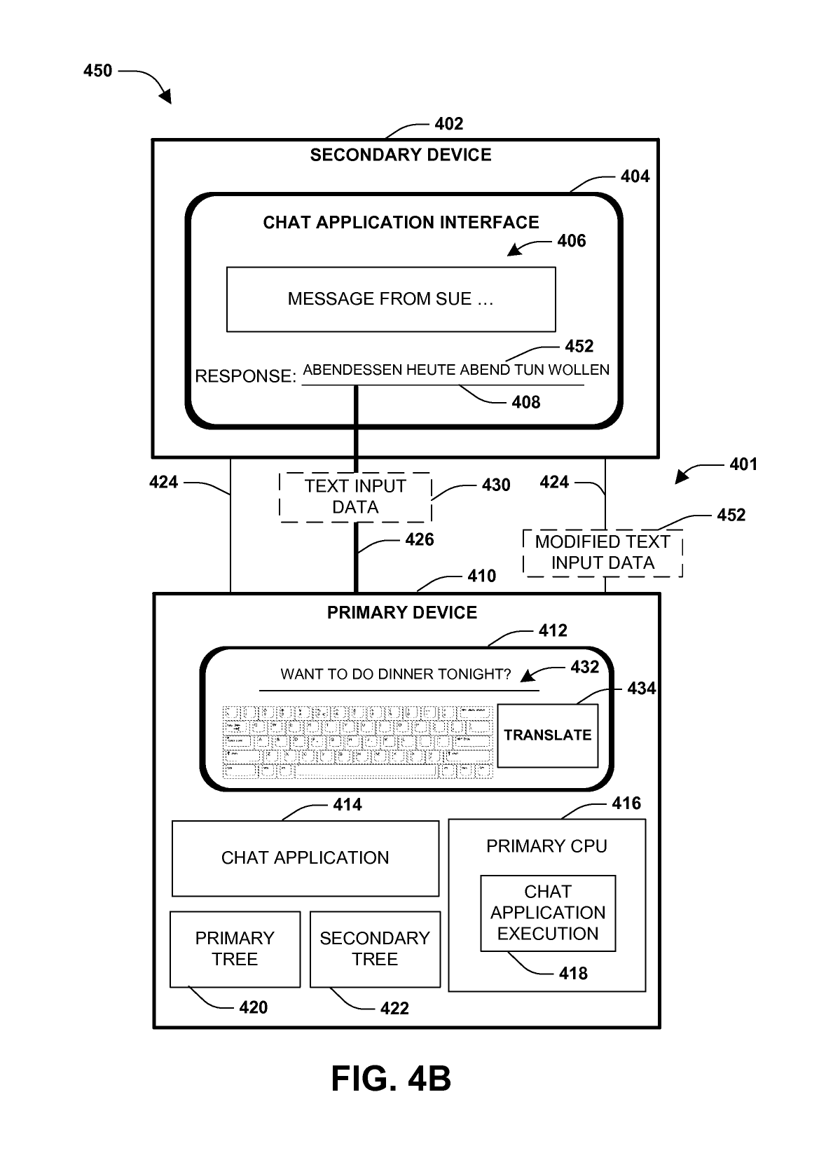

FIGS. 4A and 4B illustrate examples of a system 401, comprising a primary device 410, for providing an interactive text preview. FIG. 4A illustrates an example 400 of the primary device 410 establishing a communication channel 424 with a secondary device 402. The primary device 410 may host a chat application 414 that may execute 418 on a primary CPU 416 of the primary device 410. The primary device 410 may project a chat application interface 406, of the chat application 414, to a secondary display 404 of the secondary device 402. For example, the primary device 410 may maintain a secondary visual tree 422 comprising nodes within which user interface elements and/or display information of the chat application interface 406 and/or the secondary display 404 are stored. The primary device 410 may project the chat application interface 406 based upon the secondary visual tree 422.

The chat application interface 406 may comprise various user interface elements, such as a message 406, a text entry canvas 408 (e.g., a text input box) associated with a message response interface element, etc. In an example, the user may provide input through the primary device 410 to control the chat application interface 406. For example, although the chat application interface 406 and thus the text entry canvas 408 are not displayed on a primary display 412 of the primary device 410, a touch sensitive surface of the primary device 410 may be used as a touchpad for the secondary device 402. A swipe, tap and/or other gesture on the touch sensitive surface of the primary device 402 may therefore control movement, activity, etc. of a cursor, for example, displayed within the secondary display 404 (e.g., thus allowing the user to use the primary device 410 to place the cursor within and thus select the text entry canvas 408). A keyboard interface may be displayed on the primary display 412 of the primary device 410 (e.g., responsive to selection of the text entry canvas). The user may begin to type the phrase “Want to do dinner tonight” through the keyboard interface as input into the text entry canvas 408. As provided herein, the primary device 408 may establish an interrogation connection 426 with the text entry canvas 408. It may be appreciated that the interrogation connection 426 may allow the text input data 430 to be obtained from the execution 418 of the chat application 414 on the primary CPU 416 and/or from the secondary tree 422, and that the interrogation connection 426 is illustrated as connected to the text entry canvas 408 merely for illustrative purposes. The primary device 410 may listen through the interrogation connection 426 to identify text input data 430 directed towards the text entry canvas 408 (e.g., the text string “Want to do dinner tonight”). The primary device 410 may display an interactive text preview interface 432, populated with textual information (e.g., the text string “Want to do dinner tonight”) derived from the text input data 430, on the primary display 412 of the primary device 410. In an example, the primary device 410 may maintain a primary visual tree 420 comprising nodes within which user interface elements and/or display information of the interactive text preview interface 432 and/or the primary display 412 are stored. The primary device 410 may utilize the primary visual tree 420 to display the interactive text preview interface 432.

In an example, the chat application interface 406 is projected and displayed (e.g., rendered by the primary device 410 based upon the execution 418 of the chat application 414 by the primary CPU 416) on the secondary display 404 and not the primary display 412. In an example, the interactive text preview interface 432 is displayed on the primary display 412 (e.g., concurrent with the display of the chat application interface 406 on the secondary display 404) and not the secondary display 404. In this way, additional display real estate is available because the chat application interface 406 and the interactive text preview interface 432 are not displayed on the same display. The user may naturally look at the interactive text preview interface 432 for tactile feedback while typing (e.g., through the keyboard interface) on the primary device 410 as input to the chat application interface 406 displayed on the secondary display 404.

In an example, a translate interface element 434 may be displayed through the primary display 412. FIG. 4B illustrates an example 450 of the user invoking the translate interface element 434 in order to translate the text string “Want to do dinner tonight” into a German text string “ABENDESSEN HEUTE ABEND TUN WOLLEN” for display through the text entry canvas 408 on the secondary display 404. Accordingly, the primary device 410 may modify, such as translate, the text input data 430 to create modified text input data 452 comprising the German text string “ABENDESSEN HEUTE ABEND TUN WOLLEN”. The primary device 410 may project the modified text input data 452 to the text entry canvas 408 for display through the chat application interface 406 on the secondary display 404.

According to an aspect of the instant disclosure, a system for providing interactive text preview is provided. The system includes a primary device. The primary device is configured to establish a communication channel with a secondary device. The primary device is configured to project an application interface, of an application hosted on the primary device, to a secondary display of the secondary device. The primary device is configured to establish an interrogation connection with a text entry canvas of the application interface, where the text entry canvas is displayed on the secondary display. The primary device is configured to listen through the interrogation connection to identify text input data directed towards the text entry canvas. The text input data is input into the primary device and is targeted to the secondary device. The primary device is configured to display an interactive text preview interface, populated with textual information derived from the text input data, on a primary display of the primary device.

According to an aspect of the instant disclosure, a method for providing interactive text preview is provided. The method includes establishing, by a primary device, a communication channel with a secondary device. The method includes projecting, by the primary device, an application interface, of an application hosted on the primary device, to a secondary display of the secondary device. The method includes establishing, by the primary device, an interrogation connection with a text entry canvas of the application interface, where the text entry canvas is displayed on the secondary display. The method includes listening, by the primary device, through the interrogation connection to identify text input data directed towards the text entry canvas. The method includes displaying, by the primary device, an interactive text preview interface, populated with textual information derived from the text input data, on a primary display of the primary device.

According to an aspect of the instant disclosure, a computer readable medium comprising instructions which when executed perform a method for providing interactive text preview is provided. The method includes establishing, by a primary device, a communication channel with a secondary device. The method includes maintaining, by the primary device, a primary visual tree for a primary display of the primary device. The method includes maintaining, by the primary device, a secondary visual tree for a secondary display of the secondary device. The method includes projecting, by the primary device, an application interface, of an application hosted on the primary device, to the secondary display of the secondary device based upon the secondary visual tree. The method includes establishing, by the primary device, an interrogation connection with a text entry canvas of the application interface, where the text entry canvas is displayed on the secondary display. The method includes listening, by the primary device, though the interrogation connection to identify text input data directed towards the text entry canvas. The method includes displaying, by the primary device, an interactive text preview interface, populated with textual information derived from the text input data, on the primary display of the primary device based upon the primary visual tree.

According to an aspect of the instant disclosure, a means for providing interactive text preview is provided. The means for providing interactive text preview establishes a communication channel with a secondary device. The means for providing interactive text preview projects an application interface, of an application hosted on a primary device, to a secondary display of the secondary device. The means for providing interactive text preview establishes an interrogation connection with a text entry canvas of the application interface, where the text entry canvas is displayed on the secondary display. The means for providing interactive text preview listens through the interrogation connection to identify text input data directed towards the text entry canvas. The text input data is input into the primary device and is targeted to the secondary device. The means for providing interactive text preview displays an interactive text preview interface, populated with textual information derived from the text input data, on a primary display of the primary device.

According to an aspect of the instant disclosure, a means for providing interactive text preview is provided. The means for providing interactive text preview establishes a communication channel with a secondary device. The means for providing interactive text preview maintains a primary visual tree for a primary display of a primary device. The means for providing interactive text preview maintains a secondary visual tree for a secondary display of the secondary device. The means for providing interactive text preview projects an application interface, of an application hosted on the primary device, to the secondary display of the secondary device based upon the secondary visual tree. The means for providing interactive text preview establishes an interrogation connection with a text entry canvas of the application interface, where the text entry canvas is displayed on the secondary display. The means for providing interactive text preview listens though the interrogation connection to identify text input data directed towards the text entry canvas. The means for providing interactive text preview displays an interactive text preview interface, populated with textual information derived from the text input data, on the primary display of the primary device based upon the primary visual tree.

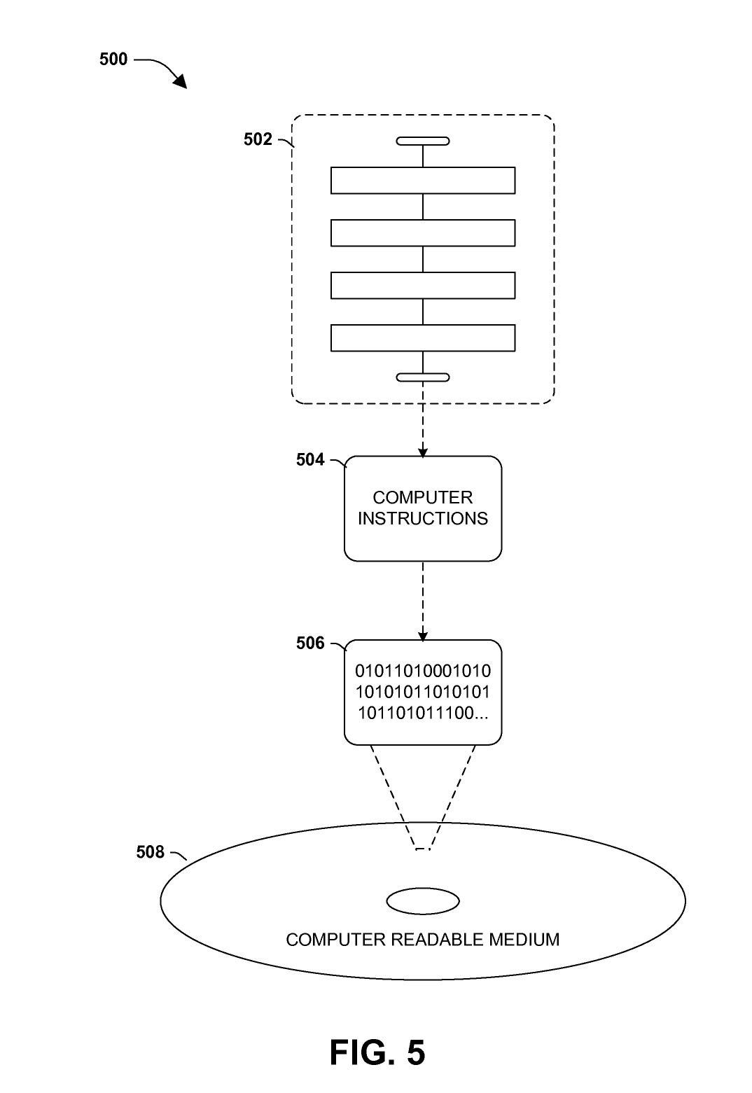

Still another embodiment involves a computer-readable medium comprising processor-executable instructions configured to implement one or more of the techniques presented herein. An example embodiment of a computer-readable medium or a computer-readable device is illustrated in FIG. 5, wherein the implementation 500 comprises a computer-readable medium 508, such as a CD-R, DVD-R, flash drive, a platter of a hard disk drive, etc., on which is encoded computer-readable data 506. This computer-readable data 506, such as binary data comprising at least one of a zero or a one, in turn comprises a set of computer instructions 504 configured to operate according to one or more of the principles set forth herein. In some embodiments, the processor-executable computer instructions 504 are configured to perform a method 502, such as at least some of the exemplary method 100 of FIG. 1, for example. In some embodiments, the processor-executable instructions 504 are configured to implement a system, such as at least some of the exemplary system 201 of FIGS. 2A and 2B, at least some of the exemplary system 301 of FIGS. 3A-3C, and/or at least some of the exemplary system 401 of FIGS. 4A and 4B, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

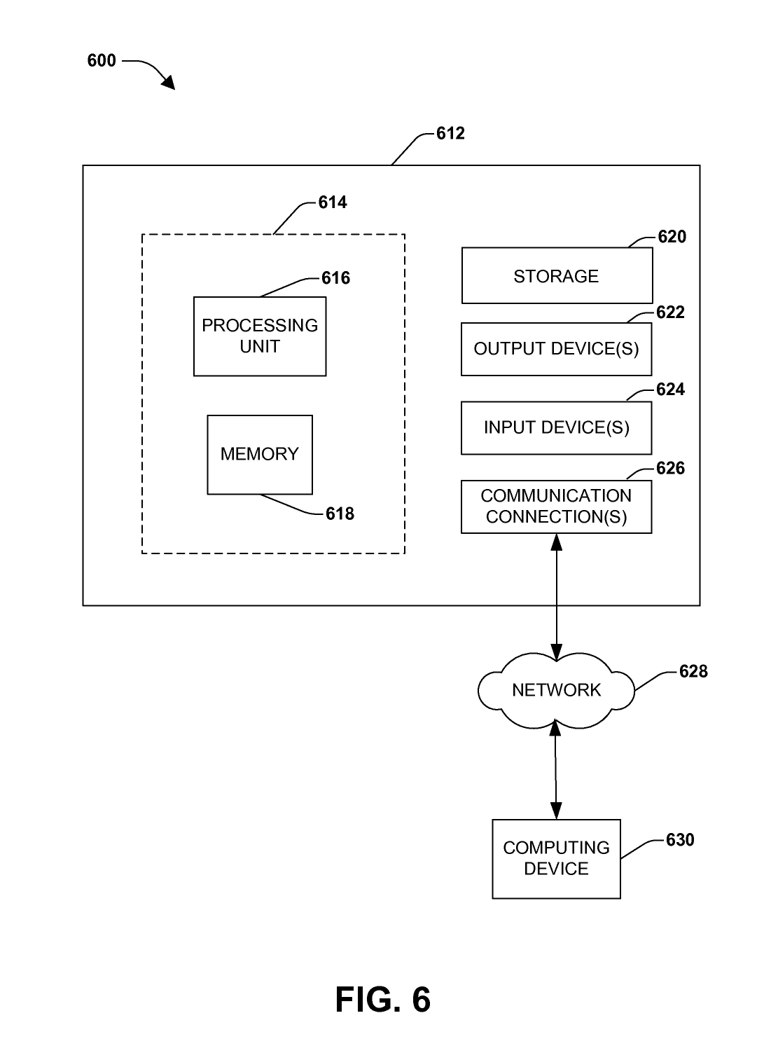

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 6 illustrates an example of a system 600 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614.

In other embodiments, device 612 may include additional features and/or functionality. For example, device 612 may also include additional storage (e.g., removable and/or non-removable) including, but not limited to, magnetic storage, optical storage, and the like. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, and the like. Computer readable instructions may be loaded in memory 618 for execution by processing unit 616, for example.

The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Computer storage media does not, however, include propagated signals. Rather, computer storage media excludes propagated signals. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, or any combination thereof. In one embodiment, an input device or an output device from another computing device may be used as input device(s) 624 or output device(s) 622 for computing device 612.

Components of computing device 612 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 612 may be interconnected by a network. For example, memory 618 may be comprised of multiple physical memory units located in different physical locations interconnected by a network.

Those skilled in the art will realize that storage devices utilized to store computer readable instructions may be distributed across a network. For example, a computing device 630 accessible via a network 628 may store computer readable instructions to implement one or more embodiments provided herein. Computing device 612 may access computing device 630 and download a part or all of the computer readable instructions for execution. Alternatively, computing device 612 may download pieces of the computer readable instructions, as needed, or some instructions may be executed at computing device 612 and some at computing device 630.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A system for providing interactive text preview, comprising:
a primary device configured to:
establish a communication channel with a secondary device;
project an application interface, of an application hosted on the primary device, to a secondary display of the secondary device;
establish an interrogation connection with a text entry canvas of the application interface, the text entry canvas displayed on the secondary display;
listen through the interrogation connection to identify text input data directed towards the text entry canvas, the text input data input into the primary device and targeted to the secondary device; and
display an interactive text preview interface, populated with textual information derived from the text input data, on a primary display of the primary device.

2. The system of claim 1, the primary device configured to:
apply a primary display characteristic to the textual information, the primary display characteristic different than a secondary display characteristic of the text entry canvas.

3. The system of claim 2, the primary display characteristic comprising a first language characteristic and the secondary display characteristic comprising a second language characteristic.

4. The system of claim 2, at least one of the primary display characteristic or the secondary display characteristic comprising at least one of a font characteristic, an aspect ratio characteristic, a color characteristic, or a user interface characteristic.

5. The system of claim 1, the interactive text preview interface not displayed on the secondary display.

6. The system of claim 1, the primary device configured to:
listen through the interrogation connection to identify a text entry canvas modification by the application hosted on the primary device to the text entry canvas displayed on the secondary display; and
update the textual information of the interactive text preview interface based upon the text entry canvas modification.

7. The system of claim 1, the application interface not displayed on the primary display.

8. The system of claim 1, the primary device configured to:
modify the text input data to create modified text input data; and
at least one of copy the modified text input data or project the modified text input data to the text entry canvas for display through the application interface on the secondary display.

9. The system of claim 1, the primary device configured to:
drive the secondary display based upon the application executing on the primary device and not executing on the secondary device.

10. The system of claim 1, the primary device configured to:
responsive to receiving a user selection of at least some of the textual information populated within the interactive text preview interface, facilitate at least one of a text selection operation, a text copy operation, a text cut operation, or a text paste operation.

11. The system of claim 1, the primary device configured to:
maintain a secondary visual tree for the secondary display; and
project the application interface to the secondary display based upon the secondary visual tree.

12. The system of claim 1, the primary device configured to:
maintain a primary visual tree for the primary display, the primary visual tree indicating that the primary display has different display capabilities than the secondary display; and
display the interactive text preview interface on the primary display based upon the primary visual tree.

13. The system of claim 1, the primary device configured to:
provide tactile feedback, for the application interface displayed on the secondary display, to a user through the interactive text preview interface displayed on the primary display.

14. A method for providing interactive text preview, comprising:
establishing, by a primary device, a communication channel with a secondary device;
projecting, by the primary device, an application interface, of an application hosted on the primary device, to a secondary display of the secondary device;
establishing, by the primary device, an interrogation connection with a text entry canvas of the application interface, the text entry canvas displayed on the secondary display;
listening, by the primary device, through the interrogation connection to identify text input data directed towards the text entry canvas; and
displaying, by the primary device, an interactive text preview interface, populated with textual information derived from the text input data, on a primary display of the primary device.

15. The method of claim 14, the interactive text preview interface not displayed on the secondary display and the application interface not displayed on the primary display.

16. The method of claim 14, comprising:
providing at least one of visual feedback or tactile feedback, for the application interface displayed on the secondary display, to a user through the interactive text preview interface displayed on the primary display.

17. The method of claim 14, comprising:
applying a primary display characteristic to the textual information, the primary display characteristic different than a secondary display characteristic of the text entry canvas.

18. The method of claim 17, at least one of the primary display characteristic or the secondary display characteristic comprising at least one of a font characteristic, an aspect ratio characteristic, a color characteristic, a language characteristic, or a user interface characteristic.

19. A computer readable medium comprising instructions which when executed perform a method for providing interactive text preview, comprising:
establishing, by a primary device, a communication channel with a secondary device;
maintaining, by the primary device, a primary visual tree for a primary display of the primary device;
maintaining, by the primary device, a secondary visual tree for a secondary display of the secondary device;
projecting, by the primary device, an application interface, of an application hosted on the primary device, to the secondary display of the secondary device based upon the secondary visual tree;
establishing, by the primary device, an interrogation connection with a text entry canvas of the application interface, the text entry canvas displayed on the secondary display;
listening, by the primary device, through the interrogation connection to identify text input data directed towards the text entry canvas; and
displaying, by the primary device, an interactive text preview interface, populated with textual information derived from the text input data, on the primary display of the primary device based upon the primary visual tree.

20. The method of claim 19, the secondary visual tree indicating that the secondary display has different display capabilities than the primary display.
